(19) United States
(12) Patent Application Publication
(10) Pub. No.: US 2022/0114188 A1
(43) Pub. Date: Apr. 14, 2022

(54) Efficient Database Loading

(71) Applicant: SAP SE, Walldorf (DE)

(72) Inventors: Sreenivasulu Gelle, San Ramon, CA (US); Alexander Ocher, San Jose, CA (US)

(21) Appl. No.: 17/069,700

(22) Filed: Oct. 13, 2020

(51) Int. Cl. G06F 16/25; G06F 16/22

(52) U.S. Cl. CPC G06F 16/254; G06F 16/2282

(57) ABSTRACT

Embodiments increase the efficiency of uploading data to a remote system. An expected volume of data for upload, is calculated prior to the actual load event. This calculation allows proactive allocation of resources (e.g., processing, memory, network, disk, others) available in the remote system, in order to accommodate the load being transferred. In certain embodiments, the calculation can be based upon historical data for previous load events. According to particular embodiments, the calculation can be based upon an estimated output data volume (such as parsing the output of EXPLAIN statement for PostgreSQL) or other information provided by data source(s) or an Extract-Transform-Load (ETL) tool. Some embodiments may perform the transfer by first staging data for upload in temporary table(s) on the side of the ETL tool, prior to actually loading to the remote system. In such embodiments, record count(s) can provide a precise value of expected data load volume.

### BACKGROUND

Unless otherwise indicated herein, the approaches described in this section are not prior art to the claims in this application and are not admitted to be prior art by inclusion in this section.

Software services are increasingly being deployed on cloud systems having storage physically located in locations remote from the actual premises on which data may be generated. If a customer needs to upload data from local servers to a cloud database on a recurring basis, appropriate resources (e.g., CPU power, available memory, network bandwidth) typically need to be reserved in advance with the cloud account.

However, reserving too much resource capacity in advance for the cloud system can increase costs. Conversely, reserving insufficient resource capacity in advance for the cloud system, can create bottlenecks and degrade performance.

### SUMMARY

Embodiments increase the efficiency of uploading data to a database of a remote system. An expected volume of data for upload, is calculated prior to the actual loading event. This calculation allows proactive allocation of resources (e.g., processing, memory, network) available in the remote system, in order to efficiently accommodate the load being transferred. In certain embodiments, the calculation can be based upon historical data for previous load events. In other embodiments, the calculation can be based upon an estimated output data volume—such as parsing the output of EXPLAIN statement for PostgreSQL—or other information provided by data source(s) or an Extract-Transform-Load (ETL) tool. Still other embodiments may perform the transfer by first staging the data for upload in temporary table(s) on the side of the ETL tool, prior to actually loading to the remote system. In these embodiments, record count(s) can be used to provide a precise value of the expected volume of the data load.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows a simplified view of an Extract Transform Load (ETL) job.

FIG. 4 is a sample user interface screen showing details of resources of a remote system.

FIGS. 5A-B are simplified views of an exemplary on-premise system interacting with a remote system to load data.

FIG. 6 is a simplified view of a user interface (UI) for data loading according to an embodiment.

FIG. 7 illustrates hardware of a special purpose computing machine according to an embodiment that is configured to implement loading of data to a remote database.

FIG. 8 illustrates an example computer system.

### DETAILED DESCRIPTION

Described herein are methods and apparatuses that implement efficient loading of data to a remote database. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

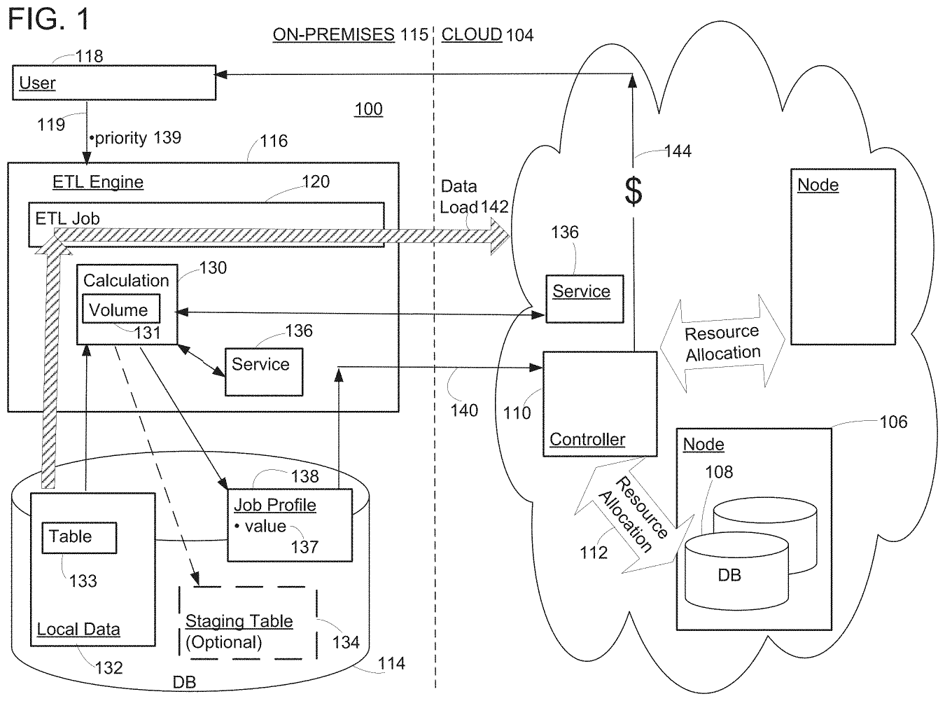

FIG. 1 shows a simplified view of an example system that is configured to implement database loading according to an embodiment. Specifically, system 100 comprises a remote system 102 located in the cloud 104.

The remote system includes a plurality of nodes 106 comprising remote database(s) 108. The remote system also includes a controller 110 that is in communication with the nodes in order to perform resource allocation 112.

The system 100 of FIG. 1 further comprises a local database 114 that is remote from the cloud system. Here, the local database is shown as being on-premises 115. However, in alternative embodiments the local database could in fact also be located on the cloud, but in a system different from the system 102.

The local database is in communication with an Extract-Transform-Load (ETL) engine 116. In particular, a user 118 provides an input 119 to the engine.

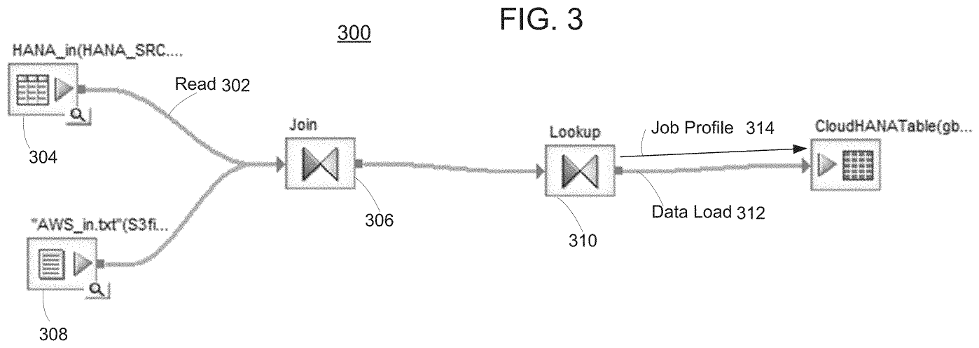

In response, the engine creates an ETL job 120. That ETL job functions to collect relevant data on premise, transform that collected data as needed, and then load the data into the cloud database. Further details regarding an exemplary ETL job are described later below in connection with FIG. 3.

Again, here in FIG. 1 the ETL engine is shown as being located on-premises. But in other (e.g., thin client) embodiments, the ETL engine could in fact also be located on the cloud in a system different from the system 102.

To aid the cloud controller in efficient resource allocation, according to embodiments the ETL engine is configured to perform a calculation 130 regarding the volume 131 of local data 132 expected for uploading as part of the ETL job. This local data may be in the form of table(s) 133.

As described below, according to some embodiments this calculation can result in an exact value for the volume. One example is where the data to be loaded is temporarily stored locally in a staging table 134 on the ETL's tool side, with record count(s) indicating the actual volume of the data for upload.

According to alternative embodiments, the calculation can result in an estimated value of the volume of the data for upload to the remote database. In one such approach, the volume of the data load can be based upon historical statistics for performing previous uploads to the remote database. Such approaches can involve the creation and training of supervised learning models.

According to a different approach, the estimated volume for upload can be based upon information available from a local or a remote source. In one example, data load volume can be calculated based upon an estimated output size resulting from parsing an execution plan used by the local database (e.g., using the output of an EXPLAIN statement for PostgreSQL).

In another example, data load volume can be calculated by an existing service 136. Such a service can be part of the ETL engine (e.g., the SAP Data Services ETL Tool discussed in the example below). Alternatively, the service can be located in the cloud system (e.g., the Google Cloud also discussed in the example below).

However calculated, the data load volume value 137 is stored in the local database as part of a job profile 138. It is noted that the job profile can contain information other than the data load volume.

For example, the job profile may describe the load topology. The job profile may include resource requirements (memory, CPU, storage, network, disk, others).

As discussed below, the job profile may also contain priority information 139—e.g., as communicated to the ETL engine as part of the user instruction. This priority information can be referenced to indicate the importance of various loading steps and activities in order to enhance optimization.

Next, the ETL engine communicates 140 the job profile to the cloud controller. The cloud controller also receives information about available resources.

In response to information in the job profile, the cloud controller dynamically acquires requested resources for optimally executing the expected data load. Under certain conditions, resources acquired to accommodate the expected data load are currently underutilized, and hence readily available.

In particular embodiments, the cloud controller may determine an optimized execution plan by collecting current workload parameters of different nodes in the cloud system. A Machine Learning (ML) model with utilization patterns may be referenced in order to distribute the load over a set of nodes.

Additionally, the calculation of resources can be done from the cloud database side after loading to its staging tables. The amount of data to be loaded may be possibly bigger than the amount of data in the staging tables, due to the same data (or its portions) being loaded to multiple tables.

Then, as shown in FIG. 1, the ETL engine causes the ETL job to communicates the actual data load 142 to the remote data database. Cloud system resources that were allocated to handle the incoming data load, may then be released for other purposes.

FIG. 1 also shows the cloud controller as communicating information 144 back to the user regarding the data uploading. This information may be a monetary cost for the upload as influenced by the priority information originally provided by the user. Thus, a more rapid data upload may be associated with a higher cost.

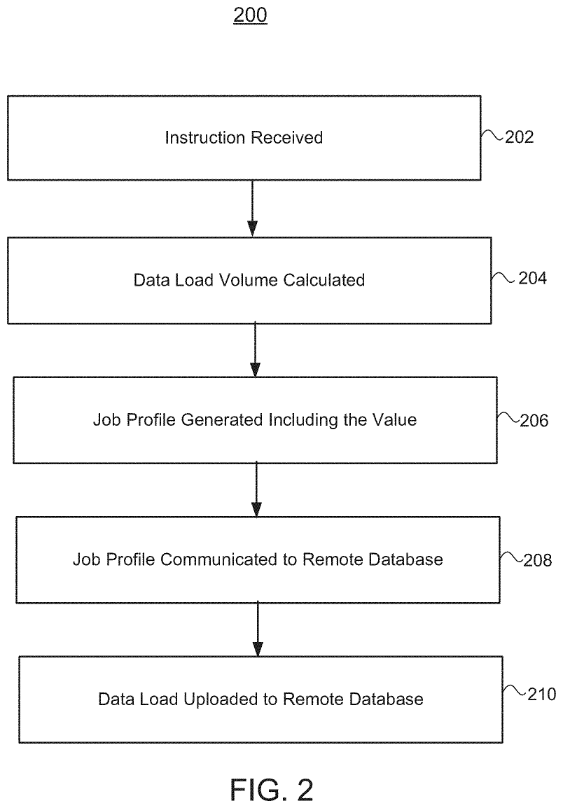

FIG. 2 is a flow diagram of a method 200 according to an embodiment. At 202, an instruction is received to upload data from a local database to a remote database. As disclosed herein, in certain embodiments this instruction may contain priority information.

At 204 a value for an expected volume of the data load, is calculated. According to some embodiments this value may be an estimated value.

At 206, a job profile including the value, is generated. In particular embodiments, the job profile may also include various details regarding topology of the data load, for example expected consumption of resources broken down by type (e.g., memory, CPU, network).

At 208, the job profile is communicated to the remote database. There, a controller may refer to the job profile to allocate resources in a manner effective to support the data load without incurring substantial unused resources.

At 210, once the job profile has been is communicated, the data load is uploaded from the local database to the remote database. Subsequently, additional communications may take place with the remote database (e.g., releasing unused resources).

Further details regarding database loading according to certain embodiments, are now provided in connection with the following example.

### Example

This specific example relates to uploading of data from a local database environment of SAP SE of Walldorf, Germany, to an SAP HANA cloud database system within the Google Cloud of GOOGLE INC, in Mountain View, Calif.

Here, the SAP customer creates an Extract-Transform-Load (ETL) job in order to:

1) collect the necessary data on premise,
2) transform the collected data as needed, and
3) load the collected/transformed data into the GOOGLE Cloud database.

In this particular example, the ETL job is performed by the Data Services (DS) tool available from SAP SE. FIG. 3 shows an example of such an ETL job 300.

This ETL job generates data, processes it, and loads it into an SAP HANA database located remotely in the Google Cloud. In particular, at 302 a table 304 is read from an on-premise HANA database.

At 306, the ETL job joins with a file 308 in Amazon cloud (Amazon Web Services, AWS, stored in a S3 file storage). At 310, the ETL job obtains enhanced data by performing a lookup from an on-premise Microsoft SQL Server database.

Lastly, at 312 the ETL job loads data into HANA database, cloud edition, located in the Google cloud. Embodiments as described herein accomplish this loading in more efficient manner utilizing by performing a calculation and providing a job profile 314 that allows the remote cloud system to allocate its resources to match the incoming data load.

As noted above, in order to enhance the efficiency of this process, embodiments may calculate the amount of data that is to be uploaded to the cloud database. This can involve generating a job profile for reference in efficiently allocating resources in the cloud.

According to this example, the calculation can be performed based upon statistical/historical data for previous loads. Such a calculation could possibly be enhanced by the use of Machine Learning (ML) approaches.

Here, in this performance test 25 Gb of data are generated locally, for upload to the HANA in-memory database within the Google Cloud. The local SAP DS ETL tool contains a job history.

Based on that job history, the DS ETL tool can know that previous executions of an ETL job were for 15 Gb and 20 Gb of data. Referencing this historical information, the instant data upload is classified as medium-large. This classification can in turn be used to determine the amount of resources needed.

In calculating the expected (25 Gb) load, the DS ETL tool can utilize its own calculator service. Alternatively, the DS ETL tool could reference a calculator service that is available from the remote, Google system.

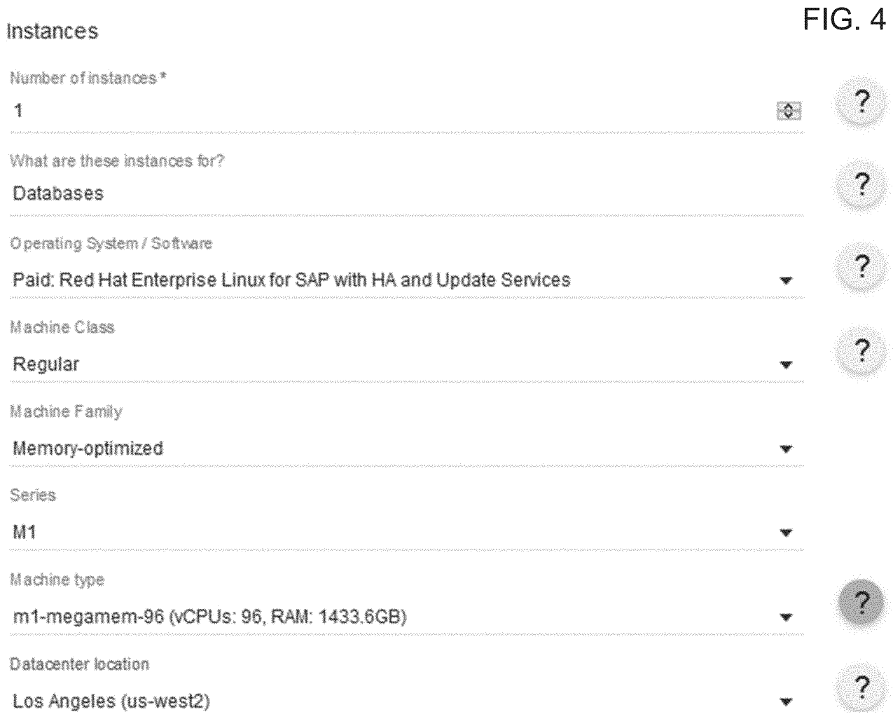

This classification information is then employed to create a profile for this ETL job. The job profile may include resource requirements (e.g., memory, CPU, storage, network). FIG. 4 is a sample user interface screen showing details of resources of a remote system.

This ETL job profile is communicated to the cloud database controller in the Google cloud. In response to receiving the job profile, the cloud database controller obtains information regarding available resources in the remote system.

The cloud database controller dynamically acquires requested resources for optimally executing the load. This may desirably involve the leveraging of currently underused resources.

The cloud database controller mentioned above, can be a generic one as provided by Google. Alternatively, the cloud database controller can be a specialized engine provided by SAP SE in order to optimize use of cloud resources by the particular account.

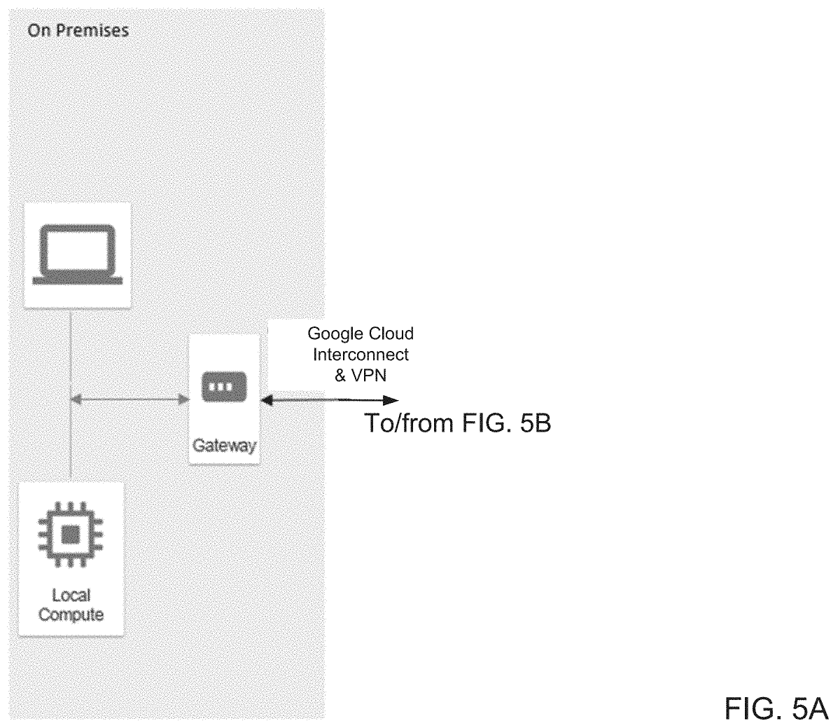

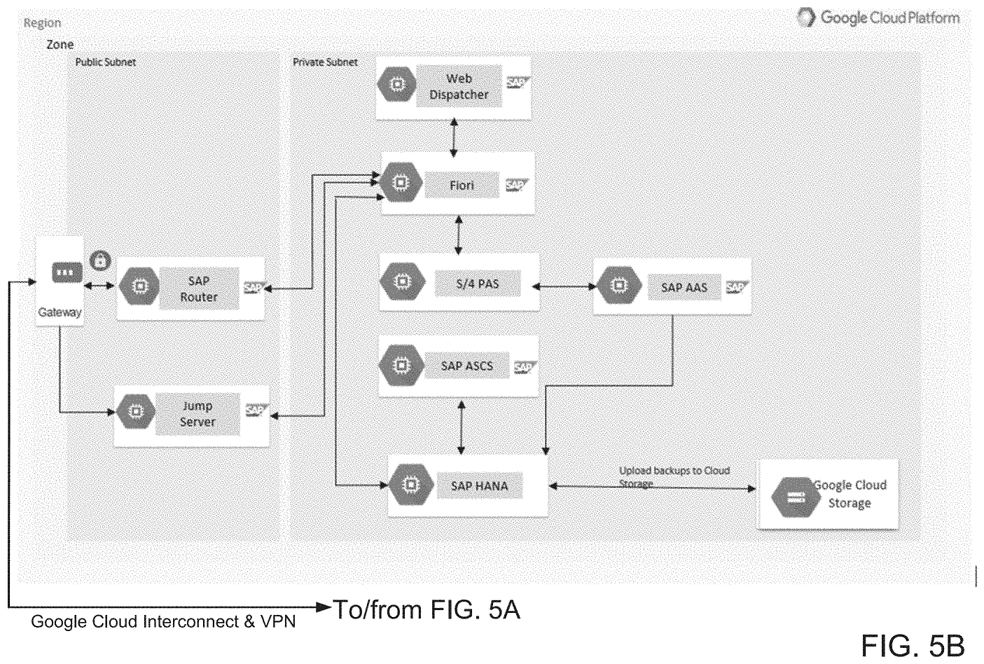

Next, the uploading occurs as usual. FIGS. 5A-B show a simplified diagram illustrating a normal loading process of data into a HANA in-memory database that is present in the Google Cloud.

Specifically, this loading utilizes Application Programming Interface (API) calls provided by the local database. The data for upload is encrypted, and then sent to the cloud database using the standard HTTP protocol.

An optional final step could occur after the loading is complete. Namely, the resources allocated for the instant ETL job may be released, so that the SAP customer does not have to pay for them anymore.

It is emphasized that the above scenario represents only one possible example of approaches for database loading according to particular embodiments. Other embodiments are possible, and there can be various modifications.

For example, some embodiments could perform a calculation based upon estimated output size. Such information could be obtained by parsing the execution plan used by the local database (e.g., using the output of an EXPLAIN statement for PostgreSQL). Alternatively, the estimate calculation could be based upon other information provided by the local source(s) or the ETL tool.

Moreover, other embodiments could stage the data to be loaded in temporary table(s) on the ETL's tool side before the load to the cloud database, and using the record count(s) as the calculation.

In some embodiments, this can be done as an on-premise look for resource availability, followed by dynamically adding resources to the remote system. On premise, these staging tables can be used to determine the actual volume of the load (rather than trying to predict that load).

Alternatively, the staging tables that are used to temporarily store the data, may be referenced by the controller located in the remote system. The remote system can then look for resource availability and add/remove resources dynamically.

It is noted that embodiments may analyze the load with more granularity than only its size. In particular, the pre-load calculation can also consider the topology of the load.

For example, it may be desired to upload 100 tables each having 20 Gb of data, to a remote system. In reality, data is rarely distributed with such uniformity. But for purposes of illustration, an actual data load can group tables into sets so the resulting distribution is more or less uniform.

Depending on the availability and cost of resources, the engine could decide to allocate a single large instance (with substantial of CPU power and memory) to load all data in parallel. Alternatively, the engine could decide to load all 100 tables sequentially, using the cheapest instance. Still further alternatively, the engine could decide upon a loading strategy lying somewhere in between these two extremes.

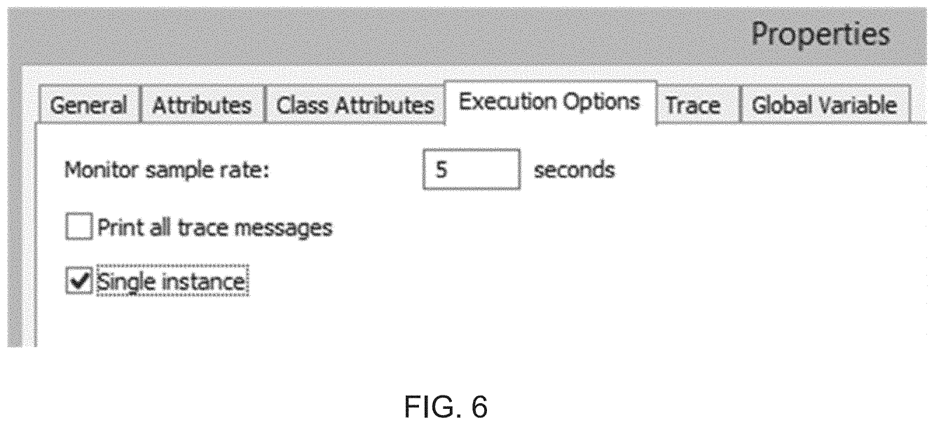

Moreover, the loading strategy could be determined in part by a priority dictated by a user. Specifically the user might specify in DS to use a single instance for loading low-priority data—relatively slowly but at low cost. The user interface (UI) screen of FIG. 6 illustrates such an approach.

Conversely, however, loading speed may be determined to be important. Then, the user may instead dictate a priority that results in the rapid processing of multiple loads. Such an approach could result in the cloud controller assessing an additional charge to the user.

Optimization may be a consideration in performing loading operations according to embodiments. In the previous example featuring 100 tables, where staging tables are used, in the cloud the same data (or its portions) can be loaded to multiple tables. This is specified in the generated job profile, and can be referenced by the HANA cloud controller.

The cloud database controller could optimize an execution plan by collecting current workload parameters of different nodes in the cloud system. Then, the cloud database controller could use a machine learning (ML) model with utilization patterns, in order to distribute the load over a set of computers in the cloud. Under such circumstances, the concept of priority (for the job and/or individual tables) may be a factor for consideration.

It is further noted that sequencing information may be considered for optimization. Thus under certain strategies, a table T3 may be loaded only if loading into tables T1 and T2 was already successful. According to other strategies, the table T3 may be loaded independent of the success or failure of attempts to upload any other table of the data load.

Returning now back to FIG. 1, there the particular embodiment is depicted with the engine responsible for implementing dynamic management of computing resources as being located outside of the database. However, this is not required.

Rather, alternative embodiments could leverage the processing power of an in-memory database engine (e.g., the in-memory database engine of the HANA in-memory database available from SAP SE), in order to perform various functions.

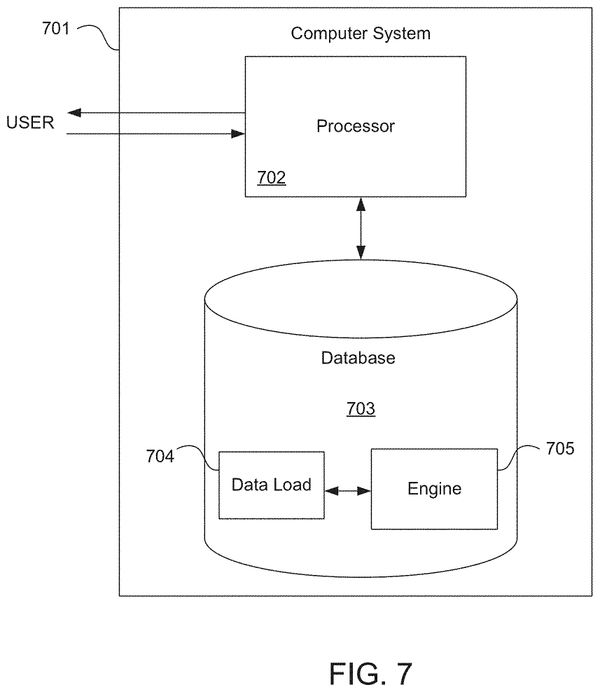

Thus FIG. 7 illustrates hardware of a special purpose computing machine configured to implement database loading according to an embodiment. In particular, computer system 701 comprises a processor 702 that is in electronic communication with a non-transitory computer-readable storage medium comprising a database 703. This computer-readable storage medium has stored thereon code 705 corresponding to an engine. Code 704 corresponds to data load that is to be uploaded. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

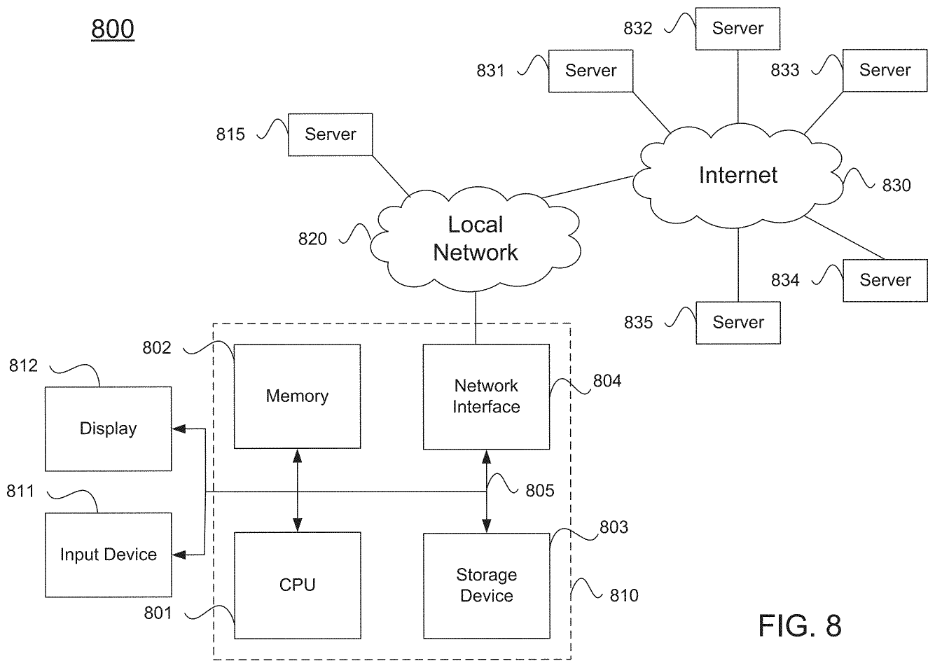

An example computer system 800 is illustrated in FIG. 8. Computer system 810 includes a bus 805 or other communication mechanism for communicating information, and a processor 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of computer readable mediums.

Computer system 810 may be coupled via bus 805 to a display 812, such as a cathode ray tube (CRT) or liquid crystal display (LCD), for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information, including messages or other interface actions, through the network interface 804 across a local network 820, an Intranet, or the Internet 830. For a local network, computer system 810 may communicate with a plurality of other computer machines, such as server 815. Accordingly, computer system 810 and server computer systems represented by server 815 may form a cloud computing network, which may be programmed with processes described herein. In the Internet example, software components or services may reside on multiple different computer systems 810 or servers 831-835 across the network. The processes described above may be implemented on one or more servers, for example. A server 831 may transmit actions or messages from one component, through Internet 830, local network 820, and network interface 804 to a component on computer system 810. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

1. (canceled)

2. A method comprising:
receiving an instruction to upload data from a local database comprising an in-memory database, to a remote database;
an in-memory database engine of the in-memory database calculating a value for an expected volume of the data;
generating a job profile including the value;
communicating the job profile to the remote database;
uploading the data to the remote database; and
releasing a resource allocated to handle the uploading;
wherein the value comprises an estimated volume, and the calculating comprises parsing an execution plan used by the local database using an output of an EXPLAIN statement for PostgreSQL.

3. A method as in claim 2 wherein the calculating is based upon historical upload jobs to the remote database.

4. A method as in claim 2 wherein the calculating references an existing service:
of a remote system including the remote database, or
of a local system including the local database.

5. (canceled)

6. (canceled)

7. A method as in claim 2 wherein:
the instruction includes a priority; and
the priority is included in the job profile.

8. A method as in claim 7 wherein the data is uploaded according to an instance determined by the priority.

9. (canceled)

10. A non-transitory computer readable storage medium embodying a computer program for performing a method, said method comprising:
receiving an instruction to upload data from a local database comprising an in-memory database, to a remote database;
an in-memory database engine of the in-memory database calculating an estimated value for an expected volume of the data;
generating a job profile including the estimated value;
communicating the job profile to the remote database; and then
uploading the data to the remote database, and
releasing a resource allocated to handle the uploading,
wherein the calculating comprises parsing an execution plan used by the local database using an output of an EXPLAIN statement for PostgreSQL.

11. A non-transitory computer readable storage medium as in claim 10 wherein the calculating is based upon historical upload jobs to the remote database.

12. (canceled)

13. A non-transitory computer readable storage medium as in claim 10 wherein the calculating references an existing service:
of a remote system including the remote database, or
of a local system including the local database.

14. A non-transitory computer readable storage medium as in claim 10 wherein:
the instruction includes a priority;
the priority is included in the job profile; and
the data is uploaded according to an instance determined by the priority.

15. A computer system comprising:
one or more processors;
a software program, executable on said computer system, the software program configured to cause an in-memory database engine of an in-memory database to:
receive an instruction to upload data from the in-memory database, to a remote database;
calculate a value for an expected volume of the data;
generate a job profile including the value;
communicate the job profile to the remote database; and then
upload the data to the remote database,
release a resource allocated to handle the upload,
wherein the value is calculated by parsing an execution plan used by the local database using an output of an EXPLAIN statement for PostgreSQL.

16. A computer system as in claim 15 wherein the value is calculated based upon historical upload jobs to the remote database.

17. (canceled)

18. (canceled)

19. A computer system as in claim 15 wherein the value is calculated by referencing an existing service:
of a remote system including the remote database, or
of a local system including the in-memory database.

20. A computer system as in claim 15 wherein:
the instruction includes a priority;
the priority is included in the job profile; and
the data is uploaded according to an instance determined by the priority.
